(19) United States
(12) Patent Application Publication
(10) Pub. No.: US 2019/0384130 A1
(43) Pub. Date: Dec. 19, 2019

(54) DISPLAY PANEL

(71) Applicant: Shenzhen China Star Optoelectronics Technology Co., Ltd., Shenzhen, Guangdong (CN)

(72) Inventors: Qing XIA, Shenzhen, Guangdong (CN); Li CHAI, Shenzhen, Guangdong (CN)

(73) Assignee: Shenzhen China Star Optoelectronics Technology Co., Ltd., Shenzhen, Guangdong (CN)

(21) Appl. No.: 15/549,538

(22) PCT Filed: Jun. 29, 2017
(86) PCT No.: PCT/CN2017/090823

§ 371 Date: Aug. 8, 2017

(30) Foreign Application Priority Data
May 31, 2017 (CN) 201710398407.8

(51) Int. Cl. G02F 1/1362; G02F 1/1343

(52) U.S. Cl. CPC G02F 1/136213; G02F 1/136227; G02F 2001/134318; G02F 1/13439; G02F 1/134309

(57) ABSTRACT

A display panel includes a pixel electrode, a common electrode line, and a dielectric layer disposed between the pixel electrode and the common electrode line. The common electrode line is made of a transparent conductive material. The common electrode line and the pixel electrode are arranged to overlap each other to form a storage capacitor.

### CROSS-REFERENCE TO RELATED APPLICATIONS

This application claims the priority of Chinese patent application CN201710398407.8, entitled “Display panel” and filed on May 31, 2017, the entirety of which is incorporated herein by reference.

### FIELD OF THE INVENTION

The present disclosure relates to the technical field of displays, and in particular, to a display panel.

### BACKGROUND OF THE INVENTION

With the development of information society, there is an increasing demand for display devices, which promotes the rapid development of liquid crystal panels. As more and more panels are produced, much higher requirements are put on quality and yield of panels. To improve quality, reduce defective ratio, and save cost have become a subject in the industry of panels.

At present, in a modular structure of a thin film transistor liquid crystal display (TFT LCD) device, an array substrate is mainly used to control switching of each pixel so as to realize control of image display. A circuit of an array substrate mainly includes wires outside the panel and wires inside the panel. Wires inside the panel are mainly used to charge and discharge pixels and hold an electric potential. Holding of the electric potential is primarily realized through a storage capacitor which is usually formed by a pixel electrode made of a transparent indium tin oxide (ITO) material and a non-transparent common electrode line arranged on a first metal layer. For the sake of aperture ratio of pixels, the storage capacitor cannot be designed with a large size.

All TFT LCD products have voltage feed-trough problems. That is to say, when a gate voltage is turned on or off, a voltage jump of a pixel charging voltage happens, which causes a pixel voltage to be asymmetrical in a negative half cycle of a positive data signal, thus resulting in flickers in the panel. Detection of flickers and optimum voltage adjustment therefore has to be considered in the design of the module.

FIG. 1 schematically shows structure of an array circuit of an existing display panel. The array circuit comprises data lines 13 and scanning lines 11 that are arranged to cross each other to form a plurality of pixel units. Each of the pixel units is provided therein with a pixel electrode 15 and a TFT 12. A gate of the TFT 12 is connected with the scanning line 11, a source thereof is connected with the data line 13, and a drain thereof is connected to the pixel electrode 15. The array circuit further comprises common electrode lines 14 which are arranged at a different layer from the pixel electrodes 15. An overlapping region between the common electrode line 14 and the pixel electrode 15 serves as a storage capacitor. When the display panel displays an image, a jumping voltage across the pixel connected with the data line 11 is expressed as: ΔV=(Vgh−Vgl)*Cgs/(Clc+Cgs+Cst+ . . . ), where Vgh is gate turn-on voltage, Vgl is gate turn-off voltage, Cgs is a stray capacitance between the gate and the source, Cls is liquid crystal capacitance, and Cst is storage capacitance. As can be seen from the expression, an increase of a value of the storage capacitance Cst can decrease a value ΔV of the jumping voltage, thereby reducing flickers in the display panel.

Because the common electrode lines 14 are usually made of non-transparent metal materials, the common electrode lines 14 cannot be designed with a large area in order to ensure aperture ratio of the pixels. As shown in FIG. 2, in the prior art, the common electrode lines 14 in FIG. 1 have a shape of an elongated strip. In this way, the overlapping region between the common electrode line 14 and the pixel electrode 15 has a small area, and a capacitance value of the storage capacitor formed from the overlapping region is also small.

FIG. 3 schematically shows a sectional view of the array circuit in FIG. 1 along line A-A. The common electrode line 14 is arranged on a substrate (not shown). A first insulation layer 16 is provided on the common electrode line 14 and an exposed portion of the substrate. The data line 13 is arranged on the first insulation layer 16. A passivation layer 17 is arranged on the data line 13 and an exposed portion of the first insulation layer 16. The pixel electrode 15 is arranged on the passivation layer 17 and is connected with the drain of the TFT 12 through a via hole (not shown). As shown in FIG. 3, the common electrode line 14 and the pixel electrode 15 are located at different layers, and the overlapping region between the two forms the storage capacitor Cst by means of a dielectric layer therebetween (i.e., the first insulation layer 16 and the passivation layer 17). However, because the common electrode line 14 in the prior art has the shape of an elongated strip, the overlapping region between the common electrode line 14 and the pixel electrode 15 is small in area, and the capacitance value of the storage capacitor formed from the overlapping region is also small.

### SUMMARY OF THE INVENTION

In order to solve the foregoing problem, the present disclosure provides a display panel which can increase a capacitance value of a storage capacitor formed by a common electrode line and a pixel electrode.

According to one embodiment of the present disclosure, a display panel is provided. The display panel comprises a pixel electrode, a common electrode line, and a dielectric layer disposed between the pixel electrode and the common electrode line. The common electrode line is made of a transparent conductive material, and the common electrode line and the pixel electrode overlap with each other to form a storage capacitor.

According to one embodiment of the present disclosure, the common electrode line is made of indium tin oxide.

According to one embodiment of the present disclosure, the common electrode line comprises: a first portion that is located in each pixel unit of the display panel and overlaps a pixel electrode of a corresponding pixel unit, and a second portion that is used to connect first portions of the common electrode line in two adjacent pixel units.

According to one embodiment of the present disclosure, an area of an overlapping region between a pixel electrode in a pixel unit and a first portion of a common electrode line in a same pixel unit accounts for 9%-100% of an area of the pixel electrode in the same pixel unit.

According to one embodiment of the present disclosure, the first portions of the common electrode line in two adjacent pixel units are connected to each other by the second portion of the common electrode line so as to form a common electrode line network.

According to one embodiment of the present disclosure, the first portion of the common electrode line in a pixel unit has a same pattern as the pixel electrode in a same pixel unit.

According to one embodiment of the present disclosure, the dielectric layer includes one or more insulation layers.

According to one embodiment of the present disclosure, the display panel comprises: a substrate; the common electrode line that is arranged on the substrate; a first insulation layer that is arranged on the common electrode line; a first metal layer that is arranged on the first insulation layer; a gate insulation layer that is arranged on the first metal layer; a semi-conductor layer that is arranged on the gate insulation layer; a second metal layer that is arranged on the semi-conductor layer; a second insulation layer that is arranged on the second metal layer; and a pixel electrode layer that is arranged on the second insulation layer. The pixel electrode layer is connected with the second metal layer through a via hole. The dielectric layer includes the first insulation layer, the gate insulation layer, and the second insulation layer.

According to one embodiment of the present disclosure, the display panel comprises: a substrate; a first metal layer that is arranged on the substrate; the common electrode line that is arranged at a same layer as the first metal layer; a gate insulation layer that is arranged on the first metal layer and the common electrode line; a semi-conductor layer that is arranged on the gate insulation layer; a second metal layer that is arranged on the semi-conductor layer; a second insulation layer that is arranged on the second metal layer; and a pixel electrode layer that is arranged on the second insulation layer. The pixel electrode layer is connected with the second metal layer through a via hole. The dielectric layer comprises the gate insulation layer and the second insulation layer.

According to one embodiment of the present disclosure, the display panel comprises: a substrate; a first metal layer that is arranged on the substrate; a gate insulation layer that is arranged on the first metal layer; the common electrode line that is arranged on the gate insulation layer; a first insulation layer that is arranged on the common electrode line; a semi-conductor layer that is arranged on first insulation layer; a second metal layer that is arranged on the semi-conductor layer; a second insulation layer that is arranged on the second metal layer; and a pixel electrode layer that is arranged on the second insulation layer. The pixel electrode layer is connected with the second metal layer through a via hole. The dielectric layer comprises the first insulation layer and the second insulation layer.

The present disclosure achieves the following beneficial effects.

In the present disclosure, the common electrode line is made of a transparent conductive material, by means of which the overlapping region between the common electrode line and the pixel electrode is increased, and further the capacitance value of the storage capacitor formed by the common electrode line and the pixel electrode is increased.

Other features and advantages of the present disclosure will be further explained in the following description, and will partly become self-evident therefrom, or be understood through the implementation of the present disclosure. The objectives and advantages of the present disclosure will be achieved through the structures specifically pointed out in the description, claims, and the accompanying drawings.

### BRIEF DESCRIPTION OF THE DRAWINGS

The accompanying drawings are provided for a further understanding of the present disclosure or the existing technologies, and constitute a part of the description. The drawings for the embodiments of the present disclosure, together with the embodiments of the present disclosure, are provided for illustrating the technical solutions of the present disclosure, rather than limiting the present disclosure.

FIG. 1 schematically shows structure of an array circuit of an existing display panel;

FIG. 2 schematically shows structure a common electrode line of the array circuit of FIG. 1;

FIG. 3 schematically shows a sectional view of the array circuit in FIG. 1 along line A-A;

FIG. 4 schematically shows structure of an array circuit of a display panel according to one embodiment of the present disclosure;

FIG. 5 schematically shows structure a common electrode line of the array circuit of FIG. 4;

FIG. 6 schematically shows a sectional view of the array circuit in FIG. 4 along line B-B; and

FIG. 7 schematically shows a sectional view of the array circuit in FIG. 4 along line C-C.

### DETAILED DESCRIPTION OF THE EMBODIMENTS

The present disclosure will be explained in detail below in conjunction with the embodiments and the accompanying drawings, so that one can fully understand how the present disclosure uses technical features to solve technical problems and achieve technical effects, and thereby implement the same. It should be noted that any of the embodiments and any of the technical features thereof may be combined with one another as long as no conflict is caused, and the technical solutions obtained therefrom fall into the scope of the present disclosure.

The present disclosure provides a display panel, which can increase a capacitance value of a storage capacitor formed by a pixel electrode and a common electrode line, thereby reducing a voltage jump value.

FIG. 4 schematically shows structure of an array circuit of a display panel according to one embodiment of the present disclosure. A detailed description of the present disclosure is provided below in conjunction with FIG. 4.

As shown in FIG. 4, the display panel comprises a pixel electrode 25, a common electrode line 24, and a dielectric layer (not shown in FIG. 4) between the pixel electrode and the common electrode line. The common electrode line 24 is made of a transparent conductive material, and is located at a different layer from the pixel electrode 25. The common electrode line 24 and the pixel electrode 25 overlap each other to form a storage capacitor. In the present disclosure, because the common electrode line 24 is made of a transparent conductive layer, the size of the common electrode line does not affect aperture ratio. The common electrode line 24 thus can have a large area, by means of which an overlapping region between the common electrode line 24 and the pixel electrode 25 is increased, and further a capacitance value of the storage capacitor formed by the common electrode line 24 and the pixel electrode 25 is increased.

In one embodiment of the present disclosure, the common electrode line 24 is made of indium tin oxide (ITO). Transparent ITO material is conductive, and is usually used to form the pixel electrode 25. However, in the present disclosure, the transparent ITO material, rather than a metal material usually used in the prior art, is used to form the common electrode line 24. By doing this, the common electrode line 24 is conductive and meanwhile can have an increased area on the condition that the aperture ratio is not affected. The capacitance value of the storage capacitor formed by the common electrode line 24 and the pixel electrode 25 can thus be increased. The common electrode line 24 can also be made of other transparent conductive materials, and the present disclosure is not limited thereto.

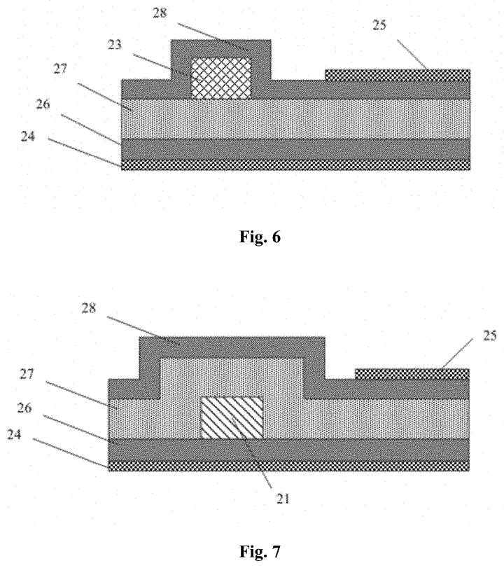

In one embodiment of the present disclosure, the common electrode line 24 comprises a first portion 241 that is located in each pixel unit of the display panel and is arranged to overlap a pixel electrode in a corresponding the pixel unit. Specifically, as shown in FIG. 5, the common electrode line 24 includes a first portion 241. Each pixel unit is provided therein with one first portion 241. The first portion 241 is arranged to overlap the pixel electrode of the pixel unit. As shown in FIG. 5, the first portion 241 of the common electrode line 24 is independent and has a planar structure.

The first portions 241 are arranged in a matrix throughout the whole display panel. As long as the overlapping region between the first portion and the pixel electrode can be increased, the first portion 241 can be in the shape of a mesh or in other shapes, and the present disclosure is not limited thereto.

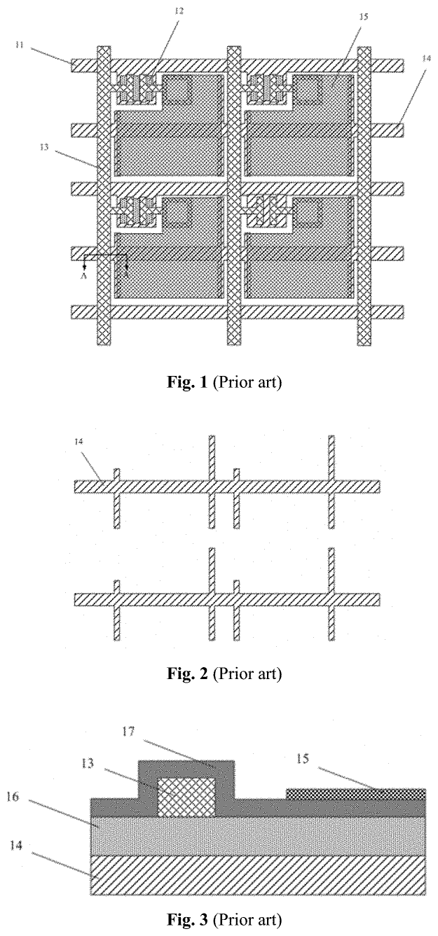

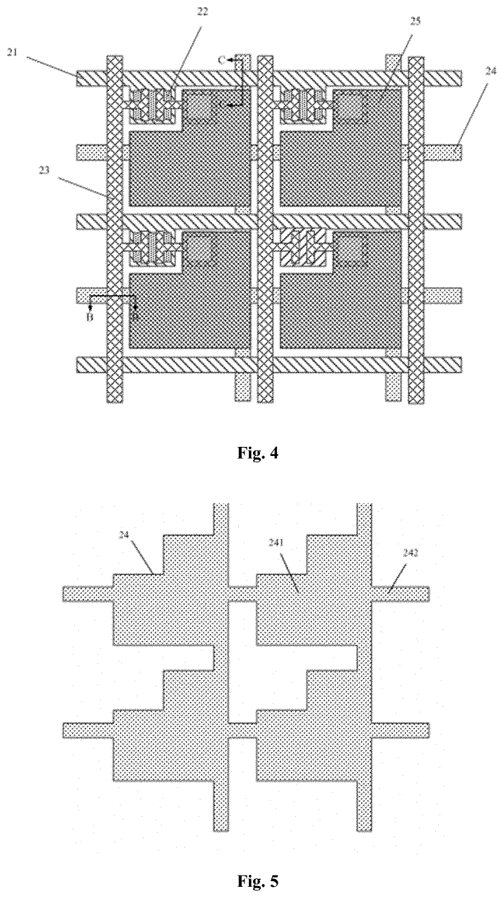

In one embodiment of the present disclosure, the overlapping region between the pixel electrode in a pixel unit and the first portion in a same pixel unit accounts for 9%-100% of an area of the pixel electrode in the same pixel unit. Specifically, as shown in FIG. 1, in the prior art, the overlapping region between the common electrode line 14 and the pixel electrode 15 accounts for about 9% of the area of the pixel electrode in the pixel unit. In the present disclosure, the common electrode line 24 is made a transparent conductive material; therefore, on the premise that light transmittance is not affected, when an area of the first portion 241 of the common electrode line 24 is increased, the overlapping region between the first portion 241 and the pixel electrode 25 is increased. In this way, the area of the overlapping region between the pixel electrode in a pixel unit and the first portion in a same pixel unit can accounts for more than 9% of the area of the pixel electrode in the same pixel unit. Preferably, the area of the overlapping region between the pixel electrode in a pixel unit and the first portion in a same pixel unit accounts for 70%-90% of the area of the pixel electrode in the same pixel unit.

In one embodiment of the present disclosure, the common electrode line 24 further comprises a second portion 242 that is located on the display panel and is connected with the first portion of the corresponding pixel unit. Specifically, as shown in FIG. 5, a plurality of second portions 242 is provided around the first portion 241 of the common electrode line 24. The plurality of second portions 242 is used for connecting the second portions 242 around the first portion 241 of an adjacent pixel unit. Thus, the first portions 241 of the common electrode line 24 are connected together as a whole, which renders it easier to supply a common voltage to the first portions 241 of the common electrode line 24.

Preferably, the first portions of the common electrode line in adjacent pixel units are connected to one another by their respective second portions to form of a common electrode line network. Specifically, as shown in FIG. 5, the first portions 241 in pixel units are connected to one another by their respective four surrounding second portions 242, forming a network of common electrode line 24, which is helpful for maintain a same electric potential at different positions of the common electrode line of the display panel. An end of the network of common electrode line is connected with an external circuit through a via hole provided outside a display area, so that a common voltage can be input to the common electrode line inside the display panel.

In one embodiment of the present disclosure, the first portion of the common electrode line 24 in a pixel unit has a same pattern as the pixel electrode in a same pixel unit, and the overlapping region between the first portion and the pixel electrode forms the storage capacitor. To be specific, as shown in FIGS. 4 and 5, the first portion 241 of the common electrode line 24 has a same pattern as the pixel electrode 25. As a result, the area of the overlapping region between the pixel electrode in the pixel unit and the corresponding first portion can be enabled to account for 100% of the area of the pixel electrode of the pixel unit, so that the storage capacitor formed by the first portion and the pixel electrode can have a maximum capacitance value, and also, additional first portions 241 are rendered unnecessary.

In one embodiment of the present disclosure, the pixel unit includes a first metal layer (including a gate line and a gate of a TFT) which is arranged on a substrate, a gate insulation layer which is arranged in the first metal layer, a semi-conductor layer which is arranged on the gate insulator layer, a second metal layer (including a data line and a source and a drain of the TFT) which is arranged on the semi-conductor layer, a second insulation layer which is arranged on the second metal layer, and a pixel electrode layer which is arranged on the second insulation layer.

FIG. 6 schematically shows a sectional view of the array circuit in FIG. 4 along line B-B. In the present embodiment, the common electrode line 24 is provided thereon with a first insulation layer 26. The first insulation layer 26 is provided thereon with a first metal layer (not shown in FIG. 6). The first metal layer is provided thereon with a gate insulation layer 27. The gate insulation layer 27 is provided thereon with a semi-conductor layer (not shown in FIG. 6). The semi-conductor layer is provided thereon with a second metal layer (which includes a data line 23 that is not shown in FIG. 6). The second metal layer is provided thereon with a second insulation layer 28. The second insulation layer 28 is provided thereon with a pixel electrode layer 25. The pixel electrode layer 25 is connected with a source and a drain of a TFT (not shown in FIG. 6) by means of a via hole (not shown in FIG. 6) provided on the second insulation layer 28.

In the present embodiment, the common electrode line 24 is located on a side of the first metal layer facing the substrate. A dielectric layer between the common electrode line 24 and the pixel electrode 25 includes the first insulation layer 26, the gate insulation layer 27, and the second insulation layer 28.

FIG. 7 schematically shows a sectional view of the array circuit in FIG. 4 along line C-C. The common electrode line 24 is provided thereon with a first insulation layer 26. The first insulation layer 26 is provided thereon with a first metal layer which includes a gate line 21 and a gate of a switching element. A gate insulation layer 27 is provided on the gate line 21 and an exposed portion of the first insulation layer 26. A second insulation layer 28 is directly arranged on the gate insulation layer 27. The second insulation layer 28 is provided thereon with the pixel electrode 25.

In the present embodiment, because the common electrode line is provided on a lowest part, the common electrode line is usually arranged on the substrate. Sometimes, the common electrode line 24 and the substrate can be provided therebetween with a buffer layer, for preventing impurities on the substrate from affecting the performance of the common electrode line 24.

It shall be appreciated that a specific location of the common electrode 24 is not limited to the present embodiment, as long as the common electrode line 24 and the pixel electrode 25 can overlap each other and form a storage capacitor therebetween by the insulating dielectric layer. For example, the common electrode line 24 can be formed by an additional photomask process after patterning of the first metal layer, and the patterned common electrode line 24 is located at a same layer as the first metal layer. Besides, the common electrode line 24 can also be provided on the gate insulation layer, and then an insulation layer can be formed on the common electrode line. Examples will not be enumerated herein.

Accordingly, a specific structure of the dielectric layer can vary with specific arrangement of the common electrode line 24. The dielectric layer can be a mono-layer structure or multi-layer structure, and will not be limited herein.

It should be noted that the above embodiments are described only for better understanding, rather than restricting the present disclosure. Anyone skilled in the art can make amendments to implementing forms and details of the present disclosure without departing from the spirit and scope of the present disclosure. The protection scope of the present disclosure is subject to the scope defined by the claims.

1. Display panel, comprising a pixel electrode, a common electrode line, and a dielectric layer disposed between the pixel electrode and the common electrode line,
wherein the common electrode line is made of a transparent conductive material, and the common electrode line and the pixel electrode overlap with each other to form a storage capacitor.

2. The display panel according to claim 1, wherein the common electrode line is made of indium tin oxide.

3. The display panel according to claim 1, wherein the common electrode line comprises:
a first portion that is located in each pixel unit of the display panel and overlaps a pixel electrode of a corresponding pixel unit, and
a second portion that is used to connect first portions of the common electrode line in two adjacent pixel units.

4. The display panel according to claim 3, wherein an area of an overlapping region between a pixel electrode in a pixel unit and a first portion of a common electrode line in a same pixel unit accounts for 9%-100% of an area of the pixel electrode in the same pixel unit.

5. The display panel according to claim 3, wherein the first portions of the common electrode line in two adjacent pixel units are connected to each other by the second portion of the common electrode line so as to form a common electrode line network.

6. The display panel according to claim 3, wherein the first portion of the common electrode line in a pixel unit has a same pattern as the pixel electrode in a same pixel unit.

7. The display panel according to claim 1, wherein the dielectric layer includes one or more insulation layers.

8. The display panel according to claim 1, comprising:
a substrate;
the common electrode line that is arranged on the substrate;
a first insulation layer that is arranged on the common electrode line;
a first metal layer that is arranged on the first insulation layer;
a gate insulation layer that is arranged on the first metal layer;
a semi-conductor layer that is arranged on the gate insulation layer;
a second metal layer that is arranged on the semi-conductor layer;
a second insulation layer that is arranged on the second metal layer; and
a pixel electrode layer that is arranged on the second insulation layer, wherein the pixel electrode layer is connected with the second metal layer through a via hole,
wherein the dielectric layer includes the first insulation layer, the gate insulation layer, and the second insulation layer.

9. The display panel according to claim 1, comprising:
a substrate;
a first metal layer that is arranged on the substrate;
the common electrode line that is arranged at a same layer as the first metal layer;
a gate insulation layer that is arranged on the first metal layer and the common electrode line;
a semi-conductor layer that is arranged on the gate insulation layer;
a second metal layer that is arranged on the semi-conductor layer;
a second insulation layer that is arranged on the second metal layer; and
a pixel electrode layer that is arranged on the second insulation layer, wherein the pixel electrode layer is connected with the second metal layer through a via hole,
wherein the dielectric layer comprises the gate insulation layer and the second insulation layer.

10. The display panel according to claim 1, comprising:
a substrate;
a first metal layer that is arranged on the substrate;
a gate insulation layer that is arranged on the first metal layer;
the common electrode line that is arranged on the gate insulation layer;
a first insulation layer that is arranged on the common electrode line;
a semi-conductor layer that is arranged on first insulation layer;
a second metal layer that is arranged on the semi-conductor layer;
a second insulation layer that is arranged on the second metal layer; and
a pixel electrode layer that is arranged on the second insulation layer, wherein the pixel electrode layer is connected with the second metal layer through a via hole,
wherein the dielectric layer comprises the first insulation layer and the second insulation layer.
